(19) United States
(12) Patent Application Publication
(10) Pub. No.: US 2012/0044125 A1
(43) Pub. Date: Feb. 23, 2012

(54) CABLE NETWORK ANTENNA AND THE PRODUCING METHOD THEREOF

(75) Inventors: Chang Soo KWAK, Daejeon (KR); Man Seok UHM, Daejeon (KR); Dong Hwan SHIN, Daejeon (KR); In Bok YOM, Daejeon (KR); So Hyeun YUN, Daejeon (KR); Jang Sup CHOI, Daejeon (KR)

(73) Assignee: Electronics and Telecommunications Research Institute, Daejeon (KR)

(21) Appl. No.: 13/214,292

(22) Filed: Aug. 22, 2011

(30) Foreign Application Priority Data
Aug. 23, 2010 (KR) 10-2010-0081520
Apr. 18, 2011 (KR) 10-2011-0035694

(51) Int. Cl. H01Q 1/36

(52) U.S. Cl. 343/897

(57) ABSTRACT

A cable network antenna and a manufacturing method thereof are provided. The cable network antenna maintains correct positions of nodes at which a plurality of cables intersect, using a circumferential truss that minimizes transformation of a reflecting surface. Accordingly, accuracy of the reflection surface is achieved.

### CROSS-REFERENCE TO RELATED APPLICATIONS

This application claims the benefit of Korean Patent Application No. 10-2010-0081520 and of Korean Patent Application No. 10-2011-0035694, respectively filed on Aug. 23, 2010 and Apr. 18, 2011, in the Korean Intellectual Property Office, the disclosures of which are incorporated herein by reference.

### BACKGROUND

1. Field of the Invention

The present invention relates to a cable network antenna which is a deployable antenna and a manufacturing method thereof.

2. Description of the Related Art

A deployable antenna is a type of reflector antenna, which may be folded into a small volume and deployed into an antenna having a large opening surface. Types of deployable antennas include a circumferential truss network deployable antenna, an umbrella deployable antenna, a truss deployable antenna, and a hybrid deployable antenna.

The deployable antenna is conveniently stored and transported since it may be deployable from a small folded state. However, unlike a fixed antenna, the deployable antenna has a difficulty in accurately forming the reflector because nodes forming a reflecting surface of the deployable antenna may be displaced in a deployed state. Accordingly, there is a desire for a new secure deployable antenna in which a shape and angle of the reflecting surface are not varied when the deployable antenna is deployed.

### SUMMARY

An aspect of the present invention provides a circumferential truss network deployable antenna that minimizes deformation of a reflecting surface in a deployed state.

According to an aspect of the present invention, there is provided a cable network antenna including a front net having a curved surface shape that includes a plurality of grids sectioned by a plurality of intersecting first cables and a rear net having a curved surface shape that includes a plurality of grids sectioned by a plurality of intersecting second cables, a mesh configured to cover the plurality of grids of the front net from a lower part of the front net, a node cover configured to cover nodes of the front net from an upper part of the mesh and to receive the plurality of first cables at the nodes of the front net, a node body configured to receive a protruded portion generated by the nodes of the front net and to be connected with the node cover disposed at the upper part of the mesh from a lower part of the mesh, and a tension tie connection unit configured to be connected with the node body and also connected with tension ties determining a distance between the rear net and the front net.

The node cover may include a plurality of recesses to receive the plurality of first cables such that the plurality of first cables are guided at a predetermined angle from the respective nodes of the front net.

The node body may include a hole disposed in a center to receive the protruded portion generated as the plurality of first cables overlap at the nodes of the front net.

The tension ties may be connected with the tension tie connection unit having a hook form and include an elastic medium disposed in a center.

The cable network antenna may further include a circumferential truss configured to support the front net, the rear net, and the tension ties to achieve a deployment mechanism of the cable network antenna.

According to an aspect of the present invention, there is also provided a cable network antenna including a front net having a curved surface shape that includes a plurality of grids sectioned by a plurality of intersecting first cables and a rear net having a curved surface shape that includes a plurality of grids sectioned by a plurality of intersecting second cables, a mesh configured to cover the plurality of grids of the front net from a lower part of the front net, a node cover configured to cover nodes of the front net from an upper part of the mesh and to receive the plurality of first cables at the nodes of the front net and a protruded portion generated by the nodes of the front net, a node body configured to be connected with the node cover disposed at the upper part of the mesh from a lower part of the mesh, and a tension tie connection unit configured to be connected with the node body and also connected with tension ties determining a distance between the rear net and the front net.

The node cover may include a plurality of recesses to receive the plurality of first cables such that the plurality of first cables are guided at a predetermined angle from the respective nodes of the front net.

The node cover may include a hole disposed in a center to receive the protruded portion generated as the plurality of first cables overlap at the nodes of the front net.

The tension ties may be connected with the tension tie connection unit having a hook form and include an elastic medium disposed in a center.

The cable network antenna may further include a circumferential truss to support the front net, the rear net, and the tension ties to achieve a deployment mechanism of the cable network antenna.

According to an aspect of the present invention, there is also provided a cable network antenna including a front net having a curved surface shape that includes a plurality of grids sectioned by a plurality of intersecting first cables and a rear net having a curved surface shape that includes a plurality of grids sectioned by a plurality of intersecting second cables, a mesh configured to cover the plurality of grids of the front net from an upper part of the front net, a node body configured to receive the nodes of the front net from a lower part of the mesh, a node cover configured to receive a protruded portion generated by the nodes of the front net from an upper part of the mesh and to be connected with the node body with the mesh interposed between the node cover and the node body, and a tension tie connection unit configured to be connected with the node body and also connected with tension ties determining a distance between the rear net and the front net.

The node cover may include a hole disposed in a center to receive the protruded portion generated as the plurality of first cables overlap at the nodes of the front net.

The node body may include a plurality of recesses to receive the plurality of first cables such that the plurality of first cables are guided at a predetermined angle from the respective nodes of the front net.

The tension ties may be connected with the tension tie connection unit having a hook form and include an elastic medium disposed in a center.

The cable network antenna may further include a circumferential truss configured to support the front net, the rear net, and the tension ties to achieve a deployment mechanism of the cable network antenna.

### EFFECT

According to embodiments of the present invention, nodes at which a plurality of cables intersect may be maintained in correct positions and, therefore, an accurate reflecting surface may be maintained.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a structure of a deployable cable network antenna of a circumferential truss type, according to an embodiment of the present invention;

FIG. 2 is a diagram illustrating nodes formed at the front net or the rear net, seen from above, in the antenna structure of FIG. 1;

FIG. 3 is an assembly diagram illustrating a node fixing unit of a cable network antenna according to an embodiment of the present invention;

FIG. 4 is an exploded view of FIG. 3;

FIG. 5 is a diagram illustrating a cable network antenna in which a plurality of cables and a node cover are assembled, according to an embodiment of the present invention;

FIG. 6 is a diagram illustrating a cable network antenna in which a mesh, a node body, and a tension tie connection unit are assembled, according to an embodiment of the present invention;

FIG. 7 is a diagram illustrating a cable network antenna according to another embodiment of the present invention; and

FIG. 8 is a diagram illustrating a cable network antenna according to still another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

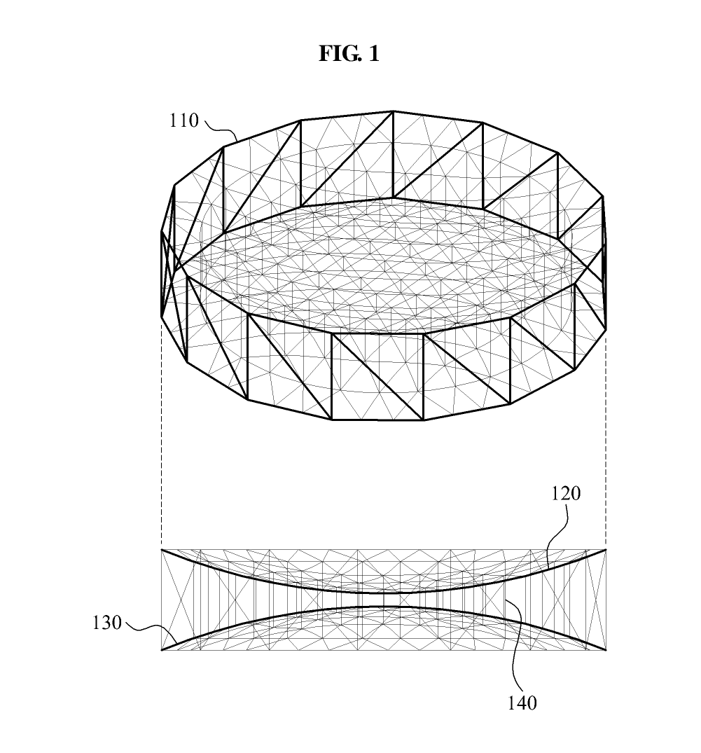

FIG. 1 is a diagram illustrating a structure of a deployable cable network antenna of circumferential truss type, according to an embodiment of the present invention. In FIG. 1, an upper drawing is a perspective view of a cable network deployable antenna and a lower drawing is a side view of the cable network deployable antenna according to the embodiment of the present invention. Hereinafter, the cable network deployable antenna will be referred to simply as ‘network antenna.’

Referring to FIG. 1, the network antenna may include a circumferential truss 110, a front net 120, a rear net 130, and a tension tie 140.

The circumferential truss 110 functions as a support structure that supports the front net 120, the rear net 130, and the tension tie 140, so as to achieve a deployment mechanism of the network antenna. That is, the front net 120 and the rear net 130 may be deployed or folded by the circumferential truss 110. The circumferential truss 110 may also control tension of the tension tie 140. Therefore, a user may reduce size of the network antenna or easily move and store the network antenna, using the circumferential truss 110.

The front net 120 may form a curved reflective surface to reflect waves. The front net 120 includes a plurality of grids sectioned by a plurality of intersecting first cables. That is, the plurality of first cables constructing the front net 120 may generate the plurality of grids by intersecting one another. The front net 120 including the plurality of grids may be shaped as a curved surface like a wide dish. Here, waves are reflected by the curved reflective surface.

The rear net 130 may also form a curved reflective surface and include a plurality of grids sectioned by a plurality of intersecting second cables. In the same manner as in the front net 120, the plurality of second cables constructing the rear net 130 may form the plurality of grids by intersecting one another.

The rear net 130 may be disposed symmetrically to the front net 120 to apply pre-tension to the front net 120.

The front net 120 and the rear net 130 are disposed symmetrically to each other. Nodes of the front net 120 and nodes of the rear net 130 are interconnected by the tension tie 140.

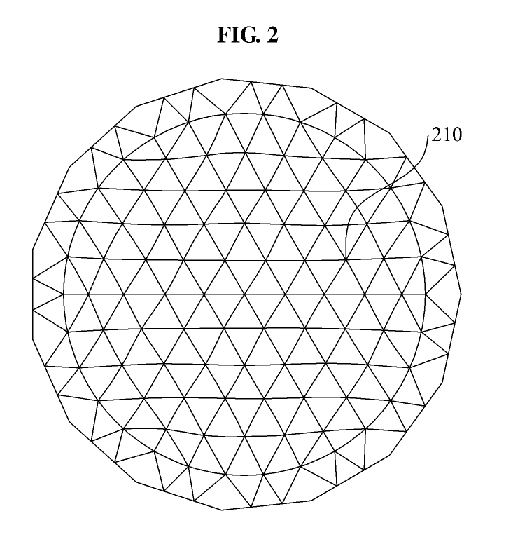

The tension tie 140 may connect nodes of the front net 120 and the rear net 130, symmetrically corresponding to each other, and apply the pre-tension to the front net 120 and the rear net 130. The nodes will be described with reference to FIG. 2.

Each of the cables constructing the front net 120 and the rear net 130 may be in the form of a thin band having a rectangular cross section. The front net 120 and the rear net 130 may be made of a light material having a high elasticity coefficient, such as Kevlar. That is, the front net 120 and the rear net 130 are rigid bodies in comparison to the tension tie 140.

Cables of the front net 120 and the rear net 130 may be in the form of the thin band having a rectangular cross section so that overlapping portions of the cables are as flat as possible. Here, for convenience and accuracy in manufacturing, the cables may be provided in a minimum number without being cut. That is, the cables may extend from one end of the circumferential truss 110 up to the opposite end without being cut.

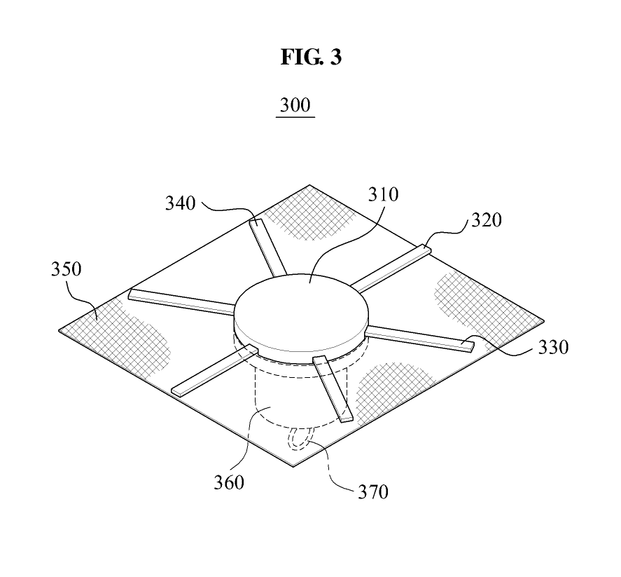

A tension tie connection unit 370 (FIG. 3) may be connected to both ends of the tension tie 140. Therefore, the nodes of the front net 120 and the rear net 130 may be connected with the tension tie 140.

The tension tie 140 may be connected with the nodes of the front net 120 and the rear net 130 through the tension tie connection unit having a form of a hook. In this instance, a center of the tension tie 140 may include an elastic medium such as a spring.

The tension tie 140 may be slightly shorter than distances between the nodes of the front net 120 and corresponding nodes of the rear net 130, so as to interconnect and apply pre-tension to the front net 120 and the rear net 130.

FIG. 2 is a diagram illustrating nodes 210 formed at the front net or the rear net, as seen from above, in the antenna structure of FIG. 1.

The nodes 210 of the front net and the rear net refer to positions in which the plurality of cables intersect. For example, when three cables intersect, the node among the three cables may have angles of about 60°. The nodes 210 need to be disposed on an ideal curved reflective surface in the network antenna. In particular, the nodes 210 need to be disposed in accurate positions on the curved reflective surface when the network antenna is in a deployed state.

Accordingly, positions of the plurality of cables constructing the nodes 210 need to be accurate. Even after the front net and the rear net are constructed and an external load such as the pre-tension is applied, the positions of the nodes 210 need to be maintained.

In particular, when the network antenna is deployed, some force may be applied to the nodes 210 through the tension tie. Here, if the cables constructing the nodes 210 slip relative to each other, the nodes 210 may be displaced. That is, such displacement is to be prevented.

Therefore, a node fixing unit as shown in FIG. 3 may be employed to form the nodes 210 more securely and accurately.

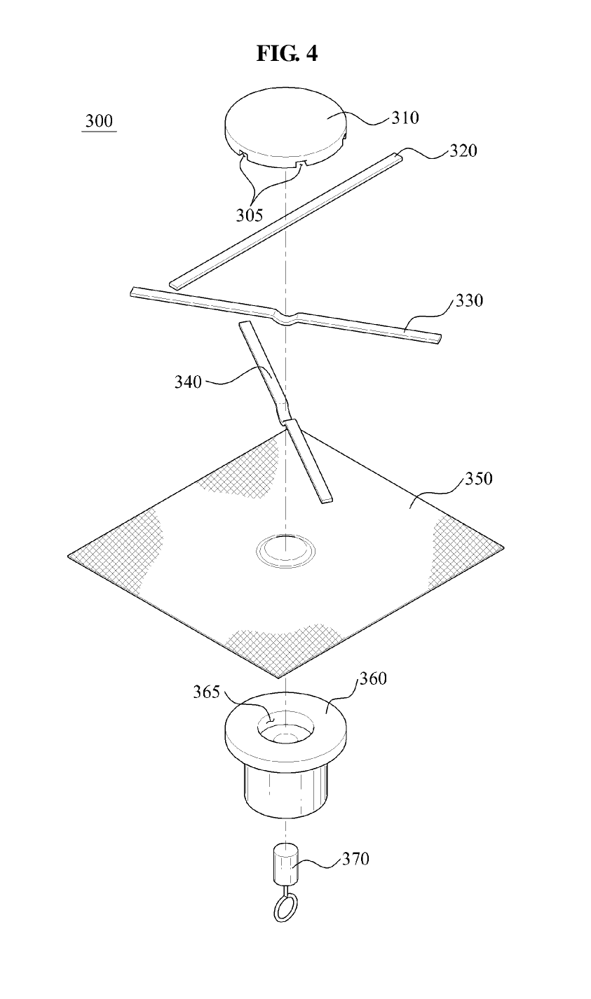

FIG. 3 is an assembly diagram illustrating a node fixing unit 300 of a network antenna according to an embodiment of the present invention. FIG. 4 is an exploded view of FIG. 3.

The network antenna may include a front net that includes a plurality of first cables 320, 330, and 340, a rear net, a mesh 350, a tension tie, a circumferential truss, and the node fixing unit 300 including a node cover 310, a node body 360, and the tension tie connection unit 370.

The foregoing descriptions of FIGS. 1 to 2 may be referred to with respect to the front net, the rear net, and the circumferential truss. Hereinafter, the node fixing unit 300 will be described in detail.

The node cover 310 may cover each of the nodes of the front net from an upper part of the mesh 350. Also, the node cover 310 may receive a plurality of first cables, that is, the cable 1 320, the cable 2 330, and the cable 3 340, at the nodes of the front net. The node cover 310 may be provided to every node of the front net and the rear net.

The node cover 310 may include a plurality of recesses 305 to receive the plurality of cables 320, 330, and 340 such that the plurality of cables are guided at a predetermined angle from the nodes of the front net.

The mesh 350 may cover a plurality of grids of the front net from a lower part of the front net constructed by the plurality of cables 320, 330, and 340.

The node body 360 may include a hole 365 to receive a protruded portion generated as the plurality of cables overlap at the node. The node body 360 may be connected with the node cover 310 disposed at the upper part of the mesh 350, from a lower part of the mesh 350.

The tension tie connection unit 370 may be connected to the node body 360 and also connected to respective tension ties (not shown) maintaining tension between the rear net and the front net.

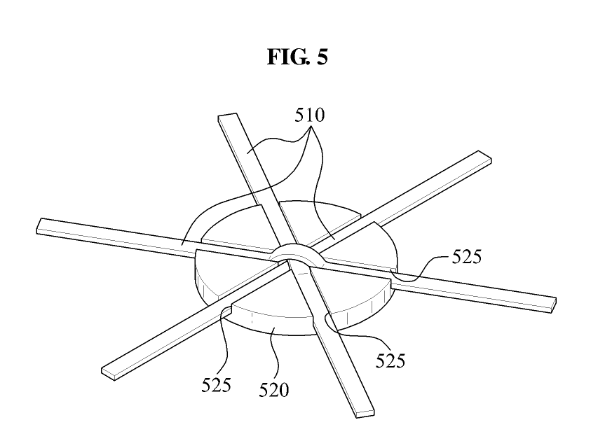

FIG. 5 is a diagram illustrating a network antenna in which a plurality of cables 510 and a node cover 520 are assembled, according to an embodiment of the present invention.

Referring to FIG. 5, the plurality of cables 510 are sequentially superposed on a node cover 520 which is in an upside-down position. The node cover 520 may include a plurality of recesses 525 to receive the plurality of cables 510 such that each of the cables 520 is guided at a predetermined angle from each node of the front net.

The plurality of cables 510 and the node cover 520 may be assembled in the following manner.

First, correct positions of the nodes are marked on the plurality of cables 510. The marked portions of the plurality of cables 510 are disposed in a center of the node cover 520. Next, the plurality of cables 510 are inserted in the recesses 525 of the node cover 520. Here, an adhesive may be applied between the node cover 520 and the plurality of cables 510 to securely fix the plurality of cables 510 to the node cover 520.

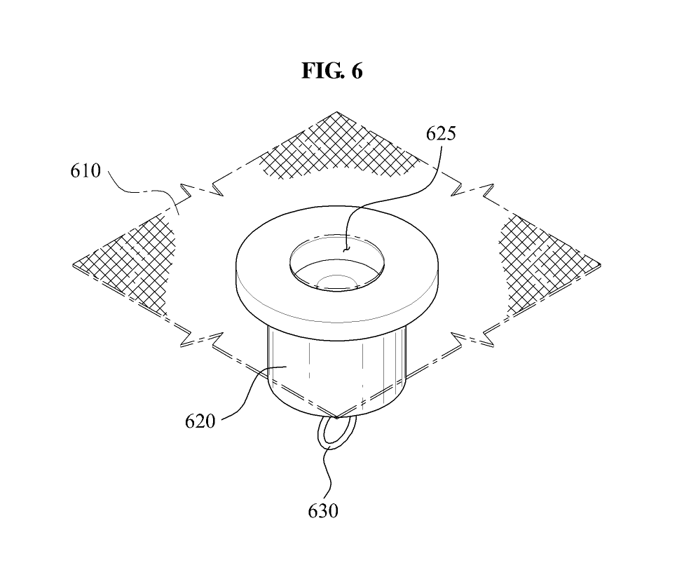

FIG. 6 is a diagram illustrating a network antenna in which a mesh 610, a node body 620, and a tension tie connection unit 630 are assembled, according to an embodiment of the present invention.

The node body 620 may be attached to a predetermined position on a lower portion of the mesh 610 by an adhesive or the like. The node body 620 may include a hole 625 to receive an overlapping portion of three cables, that is, a protruded portion generated in a center as a plurality of cables overlap at the node of the front net. Here, the protruded portion is protruded from the node cover connected with the node body 620.

In addition, the tension tie connection unit 630 may be connected to one side of the node body 620, opposite to a side connected with the mesh 610, to hook the tension tie.

The front net or the rear net may be constructed by bonding the node cover of FIG. 5 to corresponding portions of the node body 620 of FIG. 6 by an adhesive.

Here, the mesh 610 is cut into a plane surface, maintaining an outline as shown in to FIG. 2. The front net and the rear net constructed by the plurality of cables are formed as the curved surface as shown in FIG. 1. Accordingly, when the mesh 610 is connected with the front net or the rear net, the plurality of cables are separated from the mesh 610 except at the nodes.

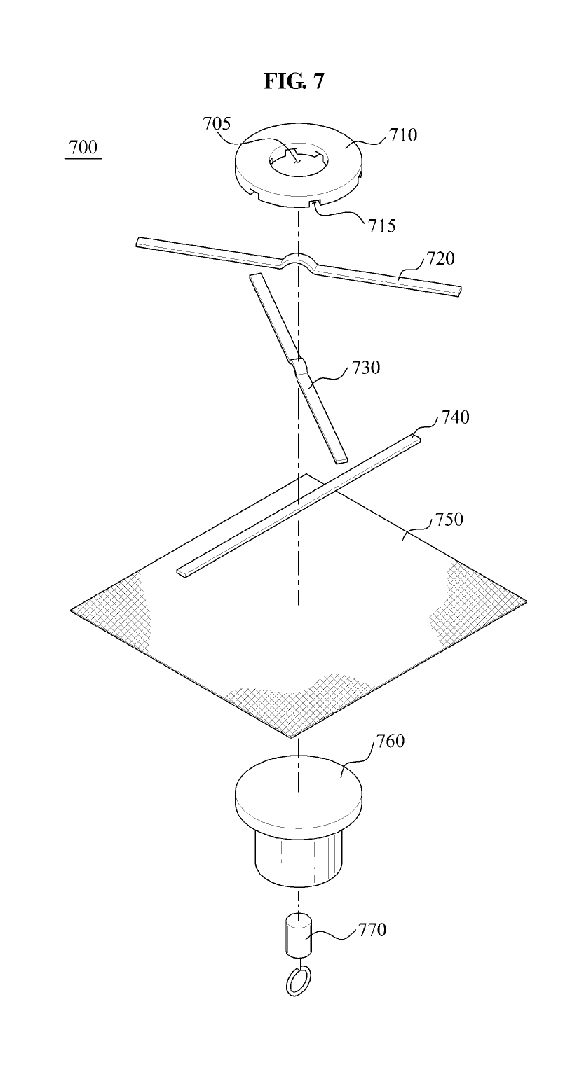

FIG. 7 is a diagram illustrating a network antenna according to another embodiment of the present invention.

The network antenna may include a front net that includes a plurality of cables 720, 730, and 740, a rear net, a mesh 750, a tension tie, a circumferential truss, and a node fixing unit 700 including a node cover 710, a node body 760, and a tension tie connection unit 770.

Here, the foregoing descriptions of FIGS. 1 to 2 may be referred to with respect to the front net, the rear net, and the circumferential truss. Hereinafter, the node fixing unit 700 will be described in detail.

The node cover 710 may cover each of the nodes of the front net from an upper part of the mesh 750. Also, the node cover 710 may receive, at each node of the front net, a protruded portion generated by each of the plurality of cables 720, 730, and 740 and each of the nodes of the front net.

The node cover 710 may include a plurality of recesses 715 to receive the plurality of cables 720, 730, and 740 such that the plurality of cables 720, 730, and 740 are guided at a predetermined angle from the nodes of the front net.

When the front net or the rear net is assembled as shown in FIG. 7, a protruded portion at which the three cables overlap may be protruded toward the node cover 710. A hole 705 may be provided to the node cover 710 to receive the protruded portion.

In other words, the node cover 710 may include the hole 705 disposed in a center to receive the protruded portion generated as the plurality of cables 720, 730, and 740 overlap at each node of the front net.

The mesh 750 may cover a plurality of grids of the front net from a lower part of the front net.

The node body 760 may be connected to the node cover 710 from a lower part of the mesh 750. Here, the node cover 710 is disposed on an upper portion of the mesh 750.

The tension tie connection unit 770 may be connected to the node body 760, and also connected to tension ties (not shown) maintaining tension between the rear net and the front net. Each of the tension ties may be connected to the tension tie connection unit 770 having a hook form and may include an elastic medium such as a spring disposed in a center.

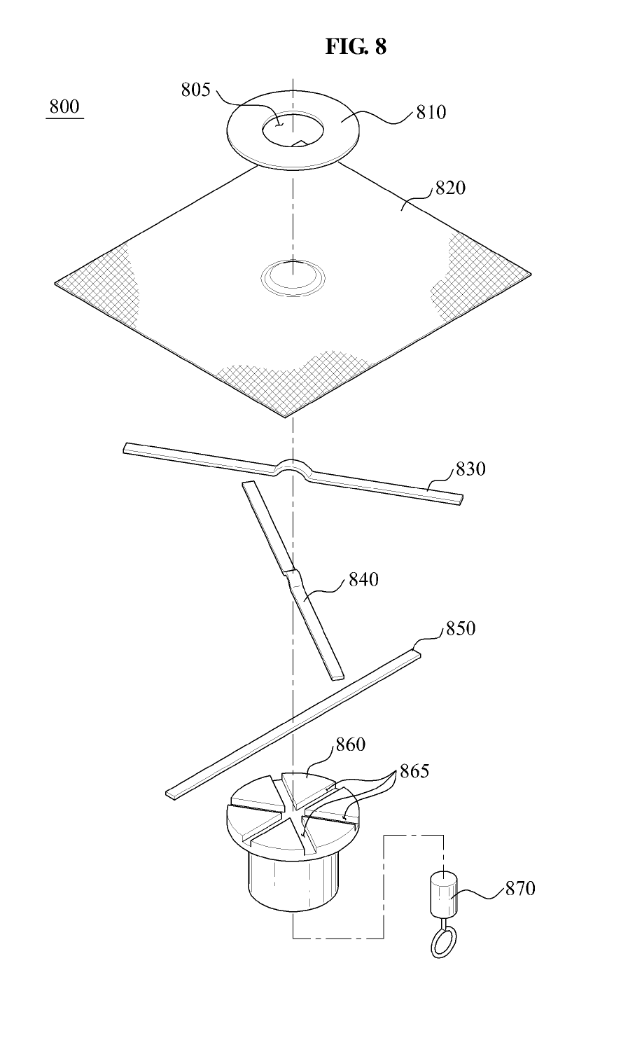

FIG. 8 is a diagram illustrating a network antenna according to still another embodiment of the present invention.

The network antenna may include a mesh 820, a front net that includes a plurality of cables 830, 840, and 850, a rear net, a tension tie, a circumferential truss, and a node fixing unit 800 including a node cover 810, a node body 860, and a tension tie connection unit 870.

Here, the foregoing descriptions of FIGS. 1 to 2 may be referred to with respect to the front net, the rear net, and the circumferential truss. Hereinafter, the node fixing unit 800 will be described in detail.

The node cover 810 may receive a protruded portion generated by each node of the front net at an upper part of the mesh 820. The node cover 810 is connected with the node body 860 with the mesh 820 interposed.

In addition, the node cover 810 may include a hole 805 disposed in a center to receive the protruded portion generated as the plurality of cables 830, 840, and 850 overlap at each node of the front net.

The node body 860 may receive each of the nodes from a lower part of the mesh 820. The node body 860 may include a plurality of recesses 865 to receive the plurality of cables 830, 840, and 850 such that the plurality of 830, 840, and 850 are guided at a predetermined angle from the nodes of the front net.

The tension tie connection unit 870 may be connected to the node body 860 and also connected to tension ties (not shown) maintaining tension between the rear net and the front net. Each of the tension ties may be connected to the tension tie connection unit 870 having a hook form and may include an elastic medium disposed in a center.

A method of manufacturing the front net and the rear net, using the node fixing unit, will now be described.

First, the plurality of cables 830, 840, and 850 marked with positions of the nodes are disposed at correct positions on the front net and the rear net, and bonded by an adhesive. The node cover 810 is bonded to a predetermined position on the mesh 820.

The two assemblies, that is, the node cover 810 and the node body 860, are bonded to each other using an adhesive. In this case, since the plurality of cables 830, 840, and 850 are received in the recesses 865 formed at the node body 860, the mesh 820 needs to be disposed at an upper part of the plurality of cables 830, 840, and 850.

In this case, due to the protruded portion generated as the plurality of cables 830, 840, and 850 overlap, the mesh 820 may also form a protruded portion. Although the protruded portion of the mesh 820 has a minor height, the embodiments described with reference to FIGS. 4 to 7 may be applied in case of an ultrahigh frequency antenna which requires high surface accuracy.

After manufacturing the front net and the rear net in the foregoing method, when the tension tie and the circumferential truss are prepared, the network antenna may be assembled in the following manner.

The circumferential truss is fully deployed. The front net and the rear net are connected to the circumferential truss. Next, the nodes of the front net and the nodes of the rear net are interconnected by the tension tie. Accordingly, the meshes of the front net and the rear net are extended, thereby forming the curved surfaces as shown in FIG. 1.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A cable network antenna comprising:
a front net having a curved surface shape that includes a plurality of grids sectioned by a plurality of intersecting first cables and a rear net having a curved surface shape that includes a plurality of grids sectioned by a plurality of intersecting second cables;
a mesh configured to cover the plurality of grids of the front net from a lower part of the front net;
a node cover configured to cover nodes of the front net from an upper part of the mesh and to receive the plurality of first cables at the nodes of the front net;
to a node body configured to receive a protruded portion generated by the nodes of the front net and to be connected with the node cover disposed at the upper part of the mesh from a lower part of the mesh; and
a tension tie connection unit configured to be connected with the node body and also connected with tension ties determining a distance between the rear net and the front net.

2. The cable network antenna of claim 1, wherein the node cover comprises a plurality of recesses to receive the plurality of first cables such that the plurality of first cables are guided at a predetermined angle from the respective nodes of the front net.

3. The cable network antenna of claim 1, wherein the node body comprises a hole disposed in a center to receive the protruded portion generated as the plurality of first cables overlap at the nodes of the front net.

4. The cable network antenna of claim 1, wherein the tension ties are connected with the tension tie connection unit having a hook form, and comprise an elastic medium disposed in a center.

5. The cable network antenna of claim 1, further comprising a circumferential truss configured to support the front net, the rear net, and the tension ties to achieve a deployment mechanism of the cable network antenna.

6. A cable network antenna comprising:
a front net having a curved surface shape that includes a plurality of grids sectioned by a plurality of intersecting first cables and a rear net having a curved surface shape that includes a plurality of grids sectioned by a plurality of intersecting second cables;
to a mesh configured to cover the plurality of grids of the front net from a lower part of the front net;
a node cover configured to cover nodes of the front net from an upper part of the mesh and to receive the plurality of first cables at the nodes of the front net and a protruded portion generated by the nodes of the front net;
a node body configured to be connected with the node cover disposed at the upper part of the mesh from a lower part of the mesh; and
a tension tie connection unit configured to be connected with the node body and also connected with tension ties determining a distance between the rear net and the front net.

7. The cable network antenna of claim 6, wherein the node cover comprises a plurality of recesses to receive the plurality of first cables such that the plurality of first cables are guided at a predetermined angle from the respective nodes of the front net.

8. The cable network antenna of claim 6, wherein the node cover comprises a hole disposed in a center to receive the protruded portion generated as the plurality of first cables overlap at the nodes of the front net.

9. The cable network antenna of claim 6, wherein the tension ties are connected with the tension tie connection unit having a hook form and comprise an elastic medium disposed in a center.

10. The cable network antenna of claim 6, further comprising a circumferential truss to support the front net, the rear net, and the tension ties to achieve a deployment mechanism of the cable network antenna.

11. A cable network antenna comprising:
a front net having a curved surface shape that includes a plurality of grids sectioned by a plurality of intersecting first cables and a rear net having a curved surface shape that includes a plurality of grids sectioned by a plurality of intersecting second cables;
a mesh configured to cover the plurality of grids of the front net from an upper part of the front net;
a node body configured to receive the nodes of the front net from a lower part of the mesh;
a node cover configured to receive a protruded portion generated by the nodes of the front net from an upper part of the mesh and to be connected with the node body with the mesh interposed between the node cover and the node body; and
a tension tie connection unit configured to be connected with the node body and also connected with tension ties determining a distance between the rear net and the front net.

12. The cable network antenna of claim 11, wherein the node cover comprises a hole disposed in a center to receive the protruded portion generated as the plurality of first cables overlap at the nodes of the front net.

13. The cable network antenna of claim 11, wherein the node body comprises a plurality of recesses to receive the plurality of first cables such that the plurality of first cables are guided at a predetermined angle from the respective nodes of the front net.

14. The cable network antenna of claim 11, wherein the tension ties are connected with the tension tie connection unit having a hook form, and comprise an elastic medium disposed in a center.

15. The cable network antenna of claim 11, further comprising a circumferential truss configured to support the front net, the rear net, and the tension ties to achieve a deployment mechanism of the cable network antenna.
